(19) United States
(12) Patent Application Publication
(10) Pub. No.: US 2004/0212735 A1
(43) Pub. Date: Oct. 28, 2004

(54) Memory card automatic display system

(75) Inventor: Takashi Kitamura, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/804,123

(22) Filed: Mar. 19, 2004

(30) Foreign Application Priority Data
Apr. 22, 2003 (JP) 2003-117292

(51) Int. Cl. H04N 5/44; G06K 5/00

(52) U.S. Cl. 348/553; 348/569

(57) ABSTRACT

There is provided a system that automatically displays and reproduces digital information recorded on a memory card by a simple user's action. When at least one memory card is inserted into at least one card slot, a display mode is switched to a mode for automatically displaying one or more images by at least one manner in accordance with the number of inserted memory cards and/or the type of card. These images indicate the recorded contents of the at least one inserted memory card.

### CROSS-REFERENCE TO RELATED APPLICATIONS

This application is based upon and claims the benefit of priority from prior Japanese Patent Application No. 2003-117292, filed Apr. 22, 2003, the entire contents of which are incorporated herein by reference.

### BACKGROUND OF THE INVENTION

1. Field of the Invention

The present invention relates to a system which can automatically display and/or can automatically reproduce digital information recorded on a memory card by a simple operation such as insertion of the memory card into a card slot and, more particularly, to a method and apparatus for automatically displaying and/or automatically reproducing digital AV information such as still pictures and the like by only inserting a memory card into a card slot.

2. Description of the Related Art

In recent years, digital cameras are popular as they can capture images of instances and can permanently record such images as digital image data. The permanent records (digital image data) can be visually reproduced again and again as needed. However, in order to visually reproduce and browse such digital image data, special apparatuses, i.e., expensive apparatuses such as a personal computer, printer, and the like are additionally required, and the user cannot easily browse such images.

By contrast, as a prior art, a method of temporarily writing digital image data on a CD-ROM, loading that CD-ROM onto a video game machine, launching an image browse program by operating a game controller, and then browsing image data has been proposed (Jpn. Pat. Appln. KOKAI Publication No. 2003-006090).

Also, a method of transferring and saving digital image data from a digital camera, connected to a television receiver that incorporates a large-capacity storage device (hard disk or the like) via a signal cable, to and in the storage device, and allowing the user to freely browse image data using the television receiver like an album has been proposed (Jpn. Pat. Appln. KOKAI Publication No. 2000-354227).

However, in these prior arts, digital image data must be temporarily written in another medium, additional equipment is required, or data which have been transferred and saved cannot be easily used outside the television receiver.

Also, the user must make complicated operations to browse image data, and some users (e.g., elderly people unaccustomed to operations of digital devices) cannot make such operations.

### BRIEF SUMMARY OF THE INVENTION

A memory card automatic display method according to an aspect of the present invention adopts a special processing step (e.g., ST20 in FIG. 4, ST200 to ST210 in FIG. 5). In this processing step, when at least one memory card is inserted into at least one card slot, a display mode is automatically switched to an image data display mode. This image data display mode is provided for automatically displaying one or more images indicating recorded contents of the at least one inserted memory card, using one or more manners (e.g., FIGS. 8 to 12) in accordance with the number of inserted cards (e.g., one to four cards) and/or the type of card (e.g., an SD card®, SmartMedia SM®) (without any user's special operation or action).

### BRIEF DESCRIPTION OF THE SEVERAL VIEWS OF THE DRAWING

FIG. 1 is a block diagram for explaining the internal arrangement of a digital AV apparatus (digital TV) according to an embodiment of the present invention;

FIG. 2 is a view showing an example of the layout of a memory card slot which is provided to the lower portion of the front surface of the AV apparatus (digital TV) shown in FIG. 1;

FIG. 3 is a view for explaining an example of a remote controller which can be used in the digital AV apparatus (digital TV) according to the embodiment of the present invention;

FIG. 4 is a flow chart for explaining an example of a process for automatically displaying the recording contents of a memory card inserted into the digital AV apparatus (digital TV) according to the embodiment of the present invention;

FIG. 5 is a flow chart for explaining an example of the processing contents of “image data display mode” in FIG. 4;

FIG. 6 is a flow chart for explaining an example of the process executed when a memory card has already been inserted into the card slot upon turning on the power switch of the apparatus;

FIG. 7 is a view for explaining an example of a display menu that prompts the user to “select a memory card, data of which are to be displayed” in the process shown in FIG. 4;

FIG. 8 is a view for explaining an example upon displaying the recording contents of a memory card inserted into the card slot in a multi-frame mode;

FIG. 9 is a view for explaining an example wherein a selected image is displayed in an enlarged scale when one image is selected from those displayed in the multi-frame mode in FIG. 8;

FIG. 10 is a view for explaining an example wherein the recording contents of a memory card inserted into the card slot are displayed in the multi-frame mode, and an image selected from those displayed in the multi-frame mode is displayed in an enlarged scale;

FIG. 11 is a view for explaining an example wherein the recording contents of two memory cards inserted into the card slots are simultaneously displayed in the multi-frame mode;

FIG. 12 is a view for explaining another example wherein the recording contents of two memory cards inserted into the card slots are simultaneously displayed in the multi-frame mode;

FIG. 13 is a view for explaining a display message in “monitor display in a no-card state” in the process shown in FIG. 4;

FIG. 14 is a view for explaining a layout example of card slots of an AV apparatus (digital TV) and a display example that informs a viewer (user) how to browse the contents of a memory card when the memory card has already been inserted into one of card slots upon turning on the power switch of the apparatus; and

FIG. 15 is a view for explaining another example of a display menu that prompts the user to “select a memory card, data of which are to be displayed” in the process shown in FIG. 4.

### DETAILED DESCRIPTION OF THE INVENTION

Systems (methods and apparatuses) according to various embodiments of the present invention will be described hereinafter with reference to the accompanying drawings.

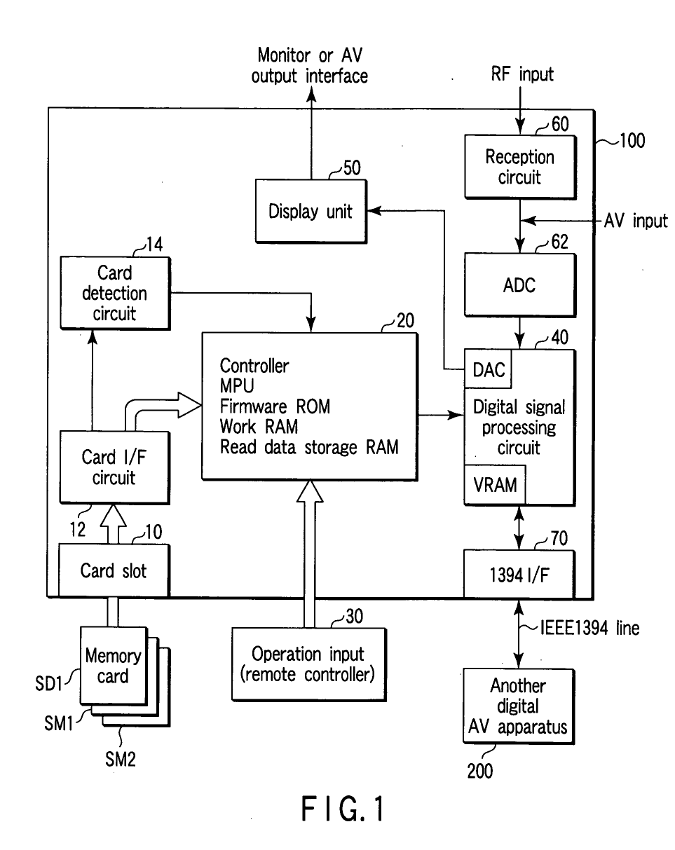

FIG. 1 is a block diagram for explaining the internal arrangement of digital AV apparatus 100 according to an embodiment of the present invention. In this embodiment, a digital TV is assumed as an example of apparatus 100, but the present invention may be applied to other digital AV apparatuses 100, e.g., a digital tuner called a settop box (STB), DVD video recorder, digital AV center, and the like. This apparatus (digital TV) 100 comprises card slot 10, card I/F circuit 12, card detection circuit 14, controller 20, digital signal processing circuit 40, display unit 50, reception circuit 60, IEEE1394 I/F 70, and the like. This I/F 70 allows a digital link of another digital AV apparatus (STB, DVD recorder, or the like) via an IEEE1394 cable.

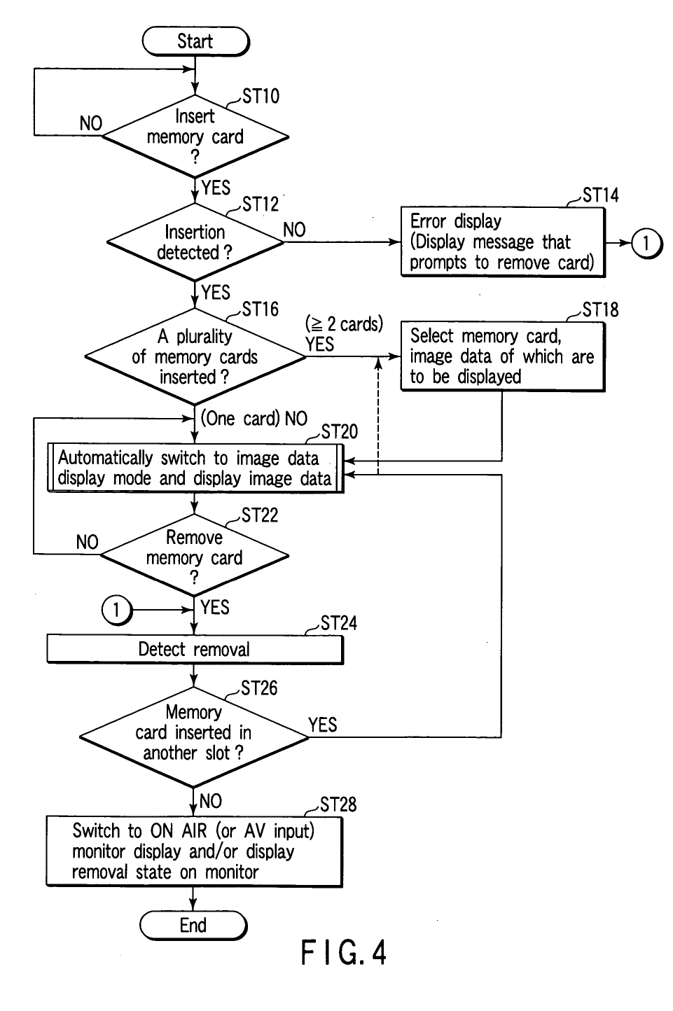

Controller 20 in FIG. 1 includes a microcomputer (to be abbreviated as an MPU hereinafter), a firmware ROM on which control programs and the like are written, a work RAM, a RAM for storing card data (e.g., a CMOS memory or EEPROM backed up by a battery), and the like. Programs that implement the processes in, e.g., FIGS. 4 to 6 are written in the firmware ROM in controller 20.

Digital signal processing circuit 40 in FIG. 1 includes a video memory (VRAM) on which various kinds of video information are mapped, a DA converter for converting various digital video signals after processing into analog video signals, and the like.

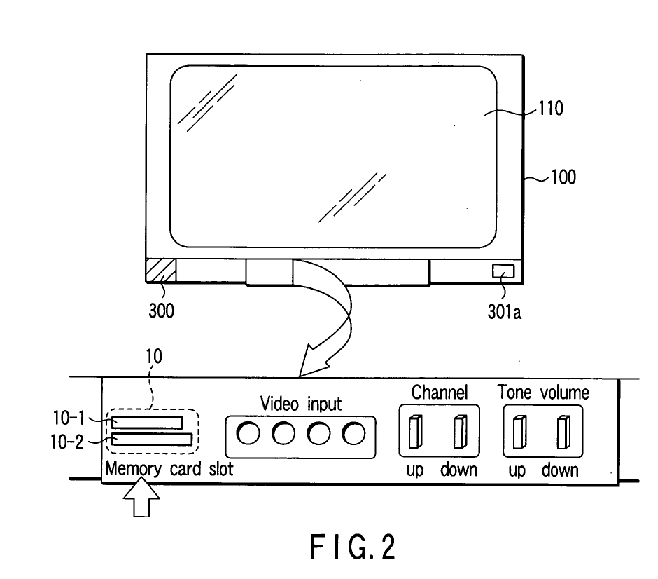

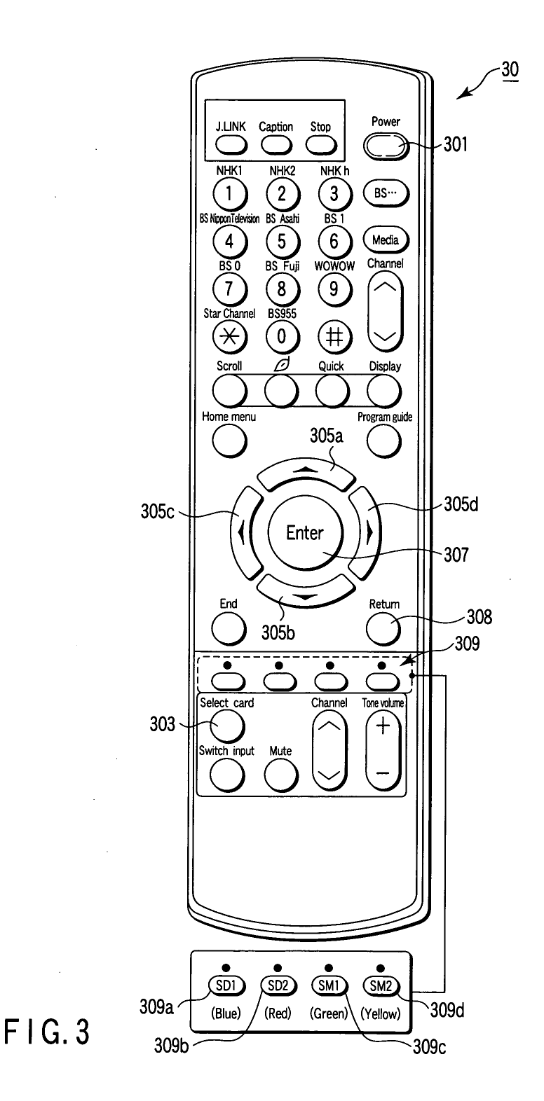

FIG. 2 shows an example of the layout of memory card slot 10 provided to the lower portion (front panel) of monitor screen 110 of apparatus (digital TV) 100 in FIG. 1. FIG. 3 shows an example of a remote controller which can be used in apparatus (digital TV) 100 in FIG. 1. FIG. 4 is a flow chart for explaining an example of the process for automatically displaying the recording contents of a memory card inserted into the digital AV apparatus (digital TV) according to the embodiment of the present invention. This process is executed by the MPU in controller 20 in FIG. 1.

In the arrangement shown in FIG. 1, apparatus (digital TV) 100 comprises multi-slot type card slot 10 which can receive one or more memory cards. As memory cards to be inserted into slot 10, for example, plate-like semiconductor memory cards such as a SmartMedia® card, SD card®, and the like used as image information storage media for digital cameras or the like may be used. In the following description, a SmartMedia card will be abbreviated as an SM card as needed.

Note that an SD card is also used in a digital solid-state recorder in addition to a digital camera, and can record audio information, text information, and the like in addition to image information. Each of these memory cards has identification information (card ID) that specifies itself, and can have file information (file system, file name information, still picture count information, photographing date information, screen size or resolution information, song title information, song count information, copy generation management information as copyright protection information, and the like) as information that pertains to the recording contents.

If one or more memory cards (SD card and/or SM card) are physically inserted into one or more card insertion ports (slots) (10-1 and 10-2 in FIG. 2) provided to card slot 10 (YES in step ST10 in FIG. 4), card I/F circuit 12 supplies electric power to the inserted cards via connection terminals (not shown). As a result, a system (not shown) in each inserted card begins to run. In this case, card detection circuit 14 detects insertion of a specific memory card (e.g., SD card SD1 in FIG. 1) into a specific card slot (e.g., 10-1 in FIG. 2).

Card detection circuit 14 informs controller 20 of the type of the card inserted into each slot. Upon reception of this insertion state information, the MPU of controller 20 can start a read process of required information from the corresponding card. If this read process cannot be started, it is determined that the card is not normally inserted.

If normal card insertion is not detected (NO in step ST12), an error message is displayed for the user (on the TV screen) (step ST14). This error message prompts the user to, e.g., remove the card. If the user has removed the card according to this message, the control jumps to a card removal detection process (step ST24; to be described later).

If it is detected that the memory card has been normally inserted into card slot 10 (YES in step ST12), it is checked. if a plurality of memory cards have been normally inserted into card slot 10. If only one card has been normally inserted (NO in step ST16), the flow advances to step ST20.

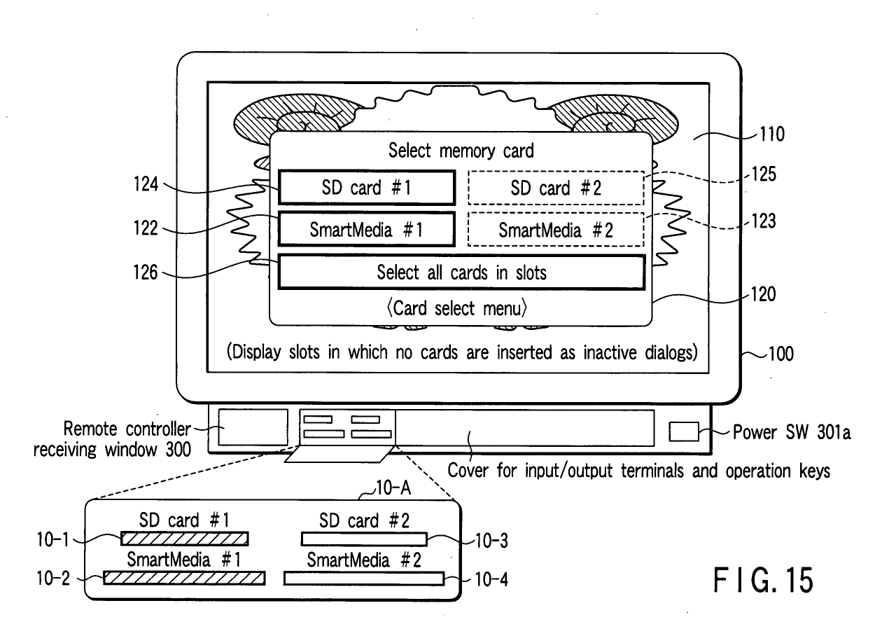

On the other hand, if two or more memory cards have been normally inserted into card slot 10 (YES in step ST16), the control prompts the user to select a memory card, image data of which are to be displayed, on the TV screen (step ST18). In such case, a menu that prompts such user's choice may be displayed, as shown in, e.g., FIG. 7 or 15. This menu normally prompts the user to select one card, but a choice that allows the user to select all of the plurality of inserted cards is also available.

Such user's choice can be made by operating buttons of remote controller 30 in FIG. 1. This remote controller 30 can have an arrangement shown in, e.g., FIG. 3. For example, when the menu shown in, e.g., FIG. 7 is displayed, the user moves a cursor to one of dialogs 122 to 126 displayed within dialog box 120 in FIG. 7 by operating cursor key 305a or 305b of the remote controller shown in FIG. 3, and presses enter button 307 of the remote controller at the desired dialog position. For example, when the user presses enter button 307 after he or she operates cursor key 305a so that dialog 122 of a SmartMedia card is bounded by a bold cursor frame, a SmartMedia card (SM card) inserted in, e.g., card slot 10-2 shown in FIG. 2, is selected.

Alternatively, when a menu window shown in, e.g., FIG. 15 is displayed, the user need only press a select button (309a to 309d), which has the same color as a desired dialog display color, of card slot direct select buttons 309 of the remote controller shown in FIG. 3. More specifically, when SD card #1 and SM card #1 are inserted into card slots 10-1 and 10-2 in FIG. 15, and no cards are inserted into card slots 10-3 and 10-4, blue dialog 124 indicating SD card #1, green dialog 122 indicating SM card #1, and white dialog 126 used to select all cards inserted into the card slots are displayed in dialog box 120 on monitor screen 110 in FIG. 15. In this case, red and yellow dialog 125 and 123 corresponding to slots 10-3 and 10-4 in which no cards are inserted are displayed as inactive dialogs, thus visually presenting that they cannot be selected by the user. In this state, when the user presses, e.g., green button 309c provided to remote controller 30 in FIG. 3, SmartMedia card (SM card) #1 inserted in card slot 10-2 in FIG. 15 is selected.

The remote controller operation result is sent to controller 20 in FIG. 1 via remote controller receiver (infrared ray receiving window) 300 provided to the lower left portion of the front surface of apparatus 100 in FIG. 2.

Note that card selection in step ST18 may be automatically made by default. As examples of default selection, a method of preferentially selecting a smaller slot number (e.g., preferentially selecting slot 10-1 over slot 10-2 in FIG. 2), a method of preferentially selecting a specific card type in accordance with the types of detected cards (e.g., preferentially selecting an SM card over an SD card), a method of preferentially selecting a card with a smaller ID of the detected cards, and the like are available.

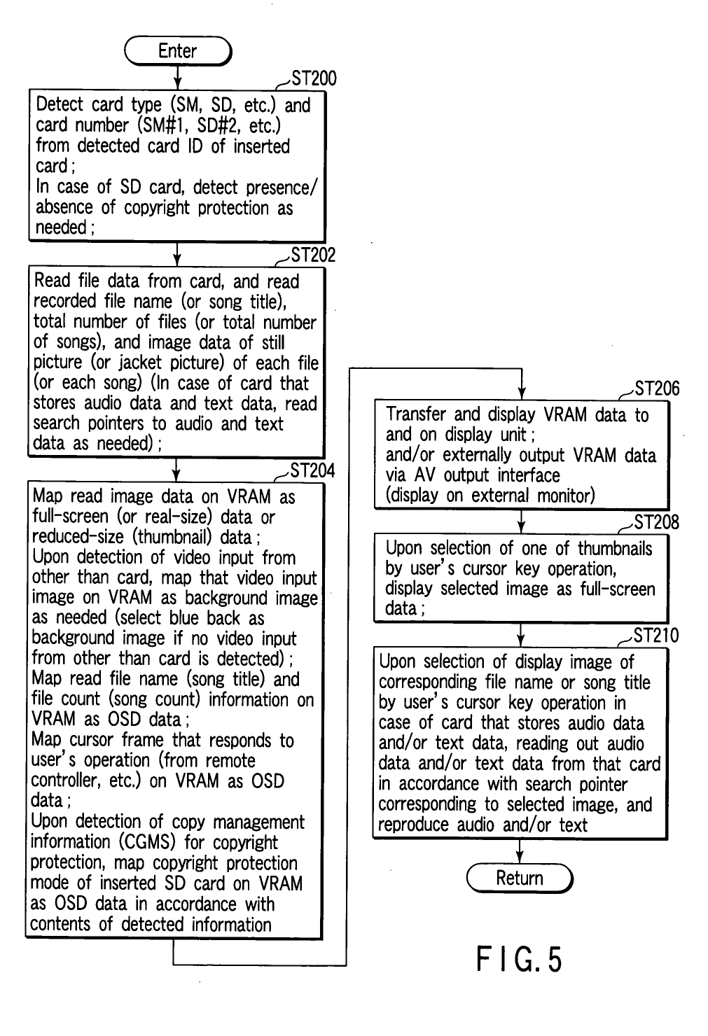

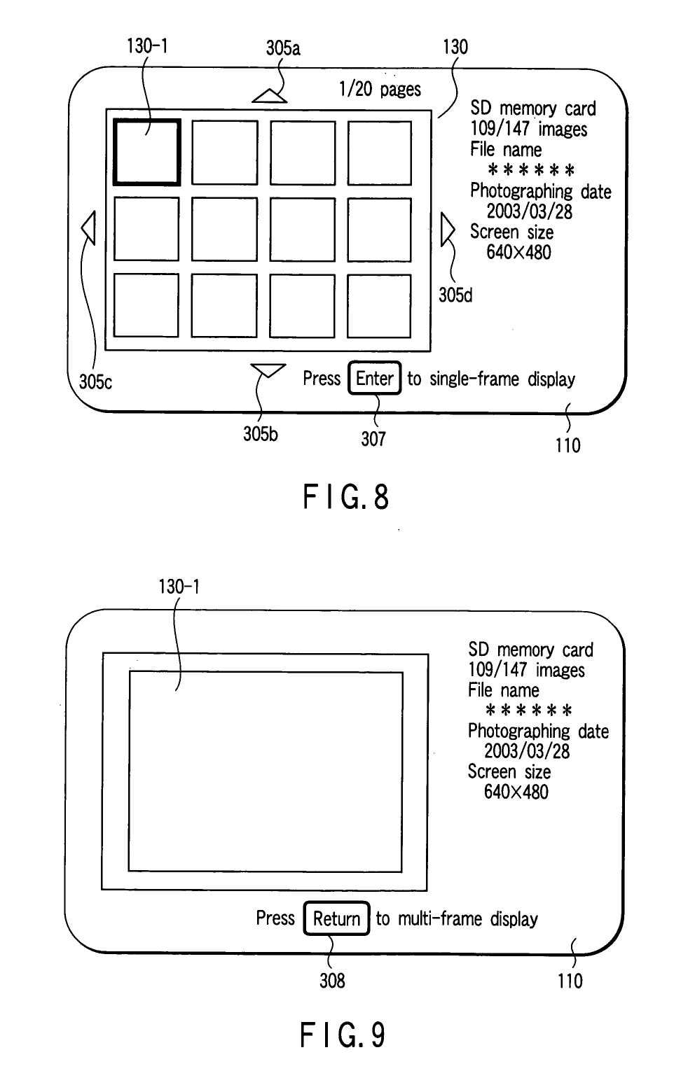

After a card to be displayed is determined by user's choice or default choice, the flow advances to step ST20. In step ST20, a mode for displaying the recording contents (image data and the like) of the selected memory card is automatically switched, a display shown in FIGS. 8 to 12 is automatically made (details of the contents of step ST20 will be described later with reference to FIG. 5).

Image data used in this display are mapped on the VRAM in digital signal processing circuit 40 in FIG. 1, and are sent to display unit 50 together with on-screen display information of additional information. Also, a video signal having the same contents as information (image data and associated information corresponding to the recording contents of the card) sent to display unit 50 can be externally output via a video monitor output or AV output interface of apparatus 100. For example, the video signal having the same contents as information sent to display unit 50 can be sent to a large-screen external monitor (not shown) via a D or S terminal or component video terminals. Then, even when display unit 50 has a small screen size, the user can browse the recording contents (still pictures and the like sensed by a digital camera) of the card on the large screen of the external monitor.

In case of the digital TV, since apparatus 100 itself has a display unit (CRT display, liquid crystal display, or plasma display), the external monitor is not always required. However, in case of an STB, AV center, or DVD recorder, apparatus 100 itself normally has no image display unit (except for a liquid crystal display unit or fluorescent display tube unit on a control panel). Therefore, upon practicing the present invention for apparatus 100 without any display unit 50, an external display device such as a TV monitor or the like is connected to its monitor output or AV output when the apparatus is used.

Upon completion of browsing of the desired recording contents of user's choice, if the memory card is removed from card slot 10 (YES in step ST22), the card removal state is detected by card detection circuit 14 (step ST24).

If a given memory card has been removed (e.g., if an SD card has been removed from slit 10-1 in FIG. 2), and if another memory card (e.g., SM card) still remains inserted in another slot (e.g., slot 10-2 in FIG. 3) (YES in step ST26), the process in step ST20 is automatically executed for the remaining memory card.

Alternatively, when two or more memory cards remain inserted after a given card has been removed, the flow may return to step ST18 to select these cards. When the flow returns to step ST20 if two or more memory cards remain inserted after a given card has been removed, one of the remaining cards may be selected by default (e.g., a card with a smaller slot number of the remaining cards may be preferentially selected).

If no memory card remains in another slot after a given memory card has been removed (NO in step ST26), the display process of the recording contents of the memory card automatically ends, and a video signal input to digital signal processing circuit 40 at that time (e.g., a broadcast image on the air received by reception circuit 60) is displayed on display unit 50 and/or the external monitor (step ST28). In this case, a dialog box (e.g., 150 in FIG. 13) that informs the user that all memory cards have been removed may be superimposed on the broadcast image as an OSD (on-screen display) message. Such “memory card removal” OSD message may be displayed in a large size for the first 10 seconds to 1 sec, and may be continuously displayed anywhere on one of four corners of monitor screen 110.

FIG. 5 is a flow chart for explaining an example of the processing contents of “image data display mode” in FIG. 4. Upon detection or selection of one or more memory cards in step ST16 or ST18 in FIG. 4, the card type (SM or SD card, or another card) and card number (SM#1, SD#2, or the like) are detected on the basis of the card ID of each detected or selected memory card. If the inserted memory card has a copyright protection function (e.g., an SD card storing music+image+text), copyright protection information (digital copy generation management information D-CGMS) is detected as needed from that card (step ST200). With this card ID, a card that stores only images (still picture card) and a card that stores audio/text data (music card) can be easily separately managed.

Next, file data are read from the memory card specified by the card ID (and/or card slot numbers 10-1 to 10-4 in which that card is inserted) (step ST202). With these data, the file names of image files (or song titles of songs) recorded in that card, the total number of tiles (or the total number of songs), and image data of a still picture (or jacket picture) corresponding to each file (or song) are read. In this case, when audio and text data are recorded on that card, search pointers to the audio and text data are also read as needed.

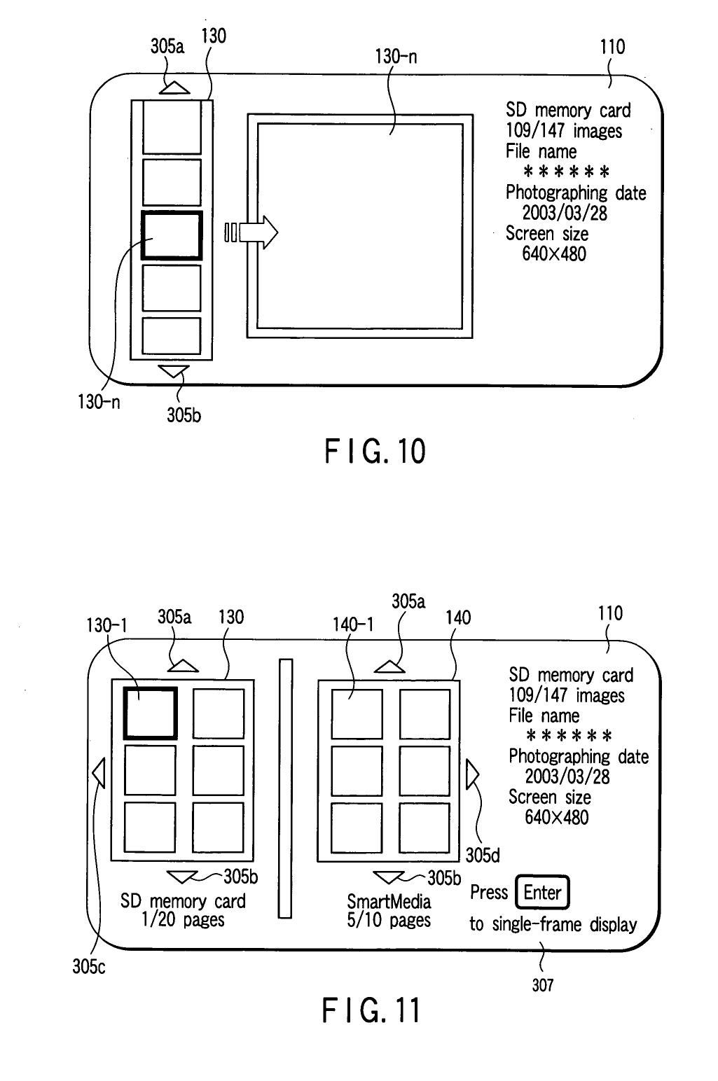

Each image data read from the memory card is mapped on the VRAM in digital signal processing circuit 40 in FIG. 1 as full-screen size (real size) or reduced size (thumbnail) data (step ST204). In case of a multi-frame display mode using thumbnail data, image data are displayed, as exemplified in FIG. 8, 11, or 12. In case of a real-size display mode, image data is displayed, as exemplified in FIG. 9. When the thumbnail display mode and the real-size display mode (or relative enlarged-size display mode) are used together, image data are displayed, as exemplified in FIG. 10 (step ST206).

In this case, if a video input from other than the memory card is detected (if a broadcast image is input from reception circuit 60 in FIG. 1 to digital signal processing circuit 40 via ADC 62), that broadcast image is mapped on the VRAM as a background image of image data from the card (or as a reduced image on another window) (step ST204). If no such video input is detected, for example, a blue back may be used as a background image of image data from the card.

The file data (information of file names/song names, file count/song count, photographing/recording date, screen size/sampling rate, compression method, play time, and the like) read from the memory card are mapped on the VRAM as OSD text data (step S204). For example, assuming that the inserted SD card records 147 still pictures, and 12 thumbnails per page corresponding to these still pictures are displayed on monitor screen 110 in the multi-frame mode, the display state of images mapped on the VRAM is as shown in, e.g., FIG. 8 (step ST206).

Furthermore, upon detection of the digital copy generation management information (D-CGMS) for copyright protection from the selected memory card, that copy management information (copy never, no more copy, copy once, or copy free) is also mapped on the VRAM (step ST204), and can be displayed as OSD data on monitor screen 110 (step ST206).

Note that a cursor frame used when the user selects thumbnails displayed in the multi-frame mode is mapped on the VRAM as OSD data (step ST204). When the user moves the cursor frame to upper left thumbnail 130-1 in FIG. 8 by operating the cursor keys (305a to 305d) of remote controller 30 in FIG. 3 and presses enter button 307 of remote controller 30 in that state, image data corresponding to thumbnail 130-1 is selected, and the selected image data is displayed as real-size (or full-screen) data on monitor screen 110 (step ST208). FIG. 9 shows that display example.

When selected thumbnail 130-1 has a link to an audio search pointer and/or text search pointer, audio data (song) and/or text data corresponding to the search pointer are/is read out from the memory card, and that song data is played back from a loudspeaker (not shown) and/or corresponding text data (an introduction comment of a singer, lyric, or the like) is displayed as OSD data on monitor screen 110 while a corresponding still picture (jacket picture) is displayed on the screen (step ST210). In this case, audio data of that song can be sent to an external audio amplifier via the AV output interface in FIG. 1.

The process in FIG. 4 assumes a case wherein no card is inserted in any card slots before the power switch of apparatus 100 in FIG. 1 is turned on. If a memory card has been inserted in one of card slots before power ON, the presence of that memory card is ignored after power ON (unless the user recognizes). The user often turns off the power switch of apparatus 100 while a memory card remains inserted in the card slot, and it is effective to inform the user that the memory card remains inserted. A measure to be taken against such case will be explained below.

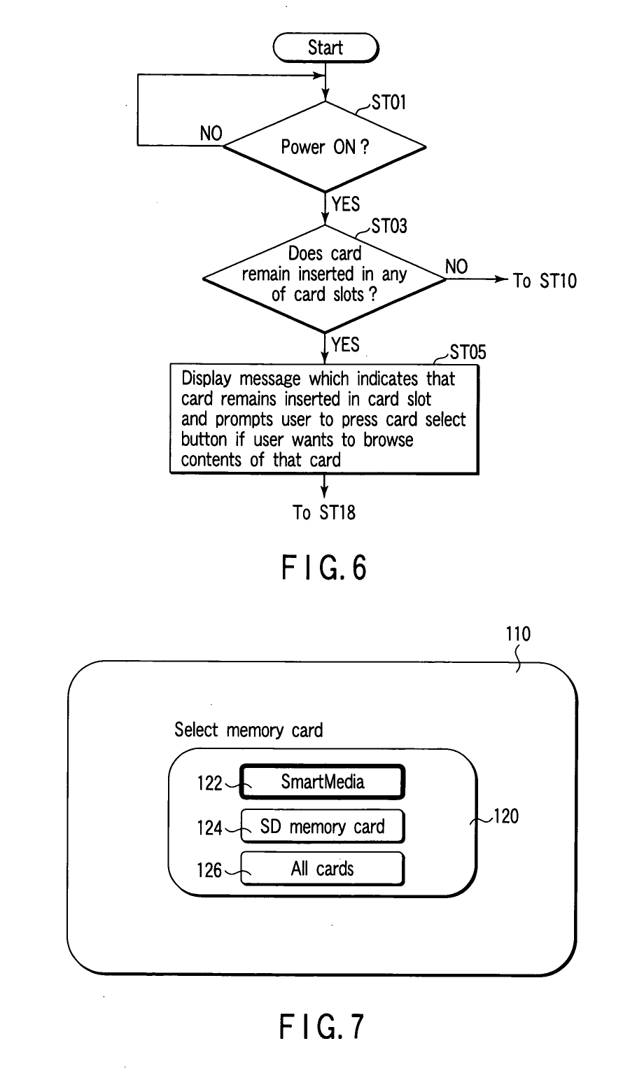

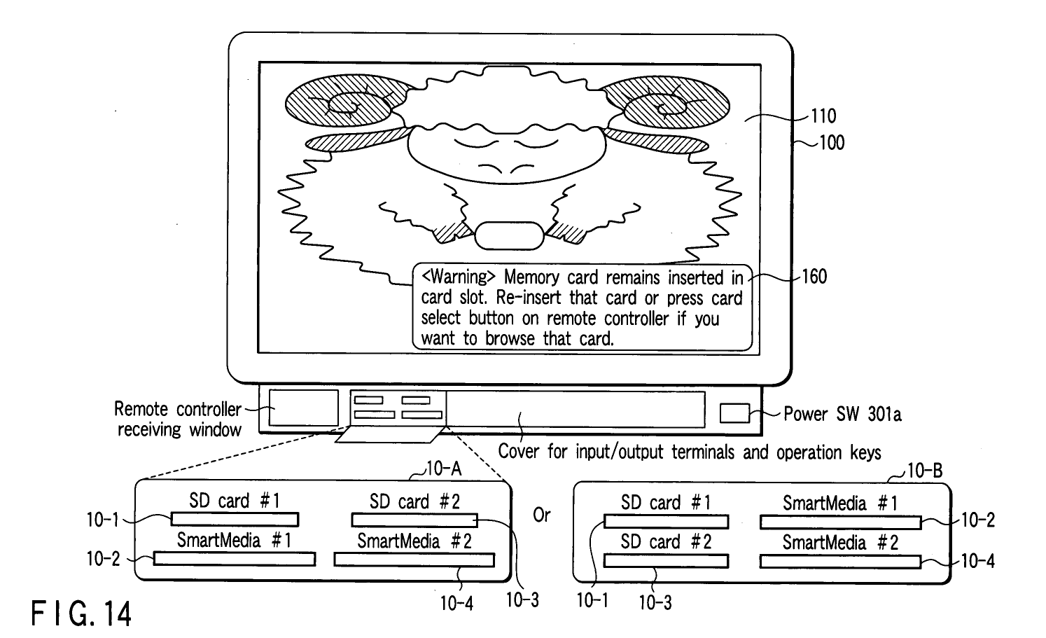

That is, FIG. 6 is a flow chart for explaining an example of the process which can be executed prior to the process in FIG. 4 when a memory card has already been inserted into the memory card slot upon turning on the power switch of the apparatus. FIG. 14 is a view for explaining a layout example of card slots of an AV apparatus (digital TV) and a display example that informs a viewer (user) how to browse the contents of a memory card when the memory card has already been inserted into one of card slots upon turning on the power switch of the apparatus. FIG. 15 is a view for explaining another example of a display menu that prompts the user to “select a memory card, data of which are to be displayed” in the process shown in FIG. 4.

When the power supply of apparatus 100 in FIG. 1 is turned on upon of power switch 301a in FIG. 2 (YES in step ST01), the MPU in controller 20 in FIG. 1 checks based on the detection result from card detection circuit 14 if a memory card is inserted into one of card slots. If no memory card is inserted into any of card slots (NO in step ST03), the flow advances to the process in step ST10 in FIG. 4.

On the other hand, if a memory card is inserted in one of the card slots (YES in step ST03), OSD messages indicating that “a memory card has been inserted in a card slot” and prompting the user to “press card select button 303 on remote controller 30 if he or she wants to browse the card contents” are displayed on monitor screen 110 (step STOS). The flow then advances to step ST18 in FIG. 4. FIG. 14 (dialog box 160) shows a display example in this case.

When the user who observed the contents of dialog box 160 in FIG. 14 presses card select button 303 in FIG. 3, card select menu dialog box 120 pops up on monitor screen 110, as exemplified in FIG. 15. In this example, SD card #1 and SmartMedia card #1 have already been inserted in card slots 10-1 and 10-2 upon power ON. When the user selects and determines one of dialogs 122, 124, and 126 in displayed dialog box 120 by remote controller operations, the control enters the process in step ST20 in FIG. 4 (steps ST200 to ST210 in FIG. 5).

FIG. 7 is a view for explaining an example of a display menu that prompts the user to “select a memory card, data of which are to be displayed” in the process shown in FIG. 4. FIG. 8 is a view for explaining an example upon displaying the recording contents of a memory card inserted into the card slot in the multi-frame mode, and FIG. 9 is a view for explaining an example wherein a selected image is displayed in an enlarged scale when one image is selected from those displayed in the multi-frame mode in FIG. 8.

That is, when a memory card is inserted into one of card slots, that insertion is detected immediately, and a mode for displaying digital image data (step ST20 in FIG. 4) starts instantaneously. Then, digital image data recorded on the memory card are loaded, and are displayed on monitor screen 110 (FIG. 8). In this case, if a plurality of memory cards are inserted, dialog box 120 used to select a memory card to be displayed, as shown in, e.g., FIG. 7, is displayed prior to monitor display of digital image data recorded on the memory cards. When the user who confirmed this display selects a desired card by operating the cursor of remote controller 30, the display mode of the corresponding card (step ST20) starts. In this case, the display format shown in FIG. 8 or 9 is used. That is, the contents of a plurality of files are initially displayed in a reduced scale (multi-frame display using thumbnails in FIG. 8). When the user who observed these thumbnails selects a thumbnail to be displayed in an enlarged scale by moving a cursor to that thumbnail by remote controller operations, display of the selected thumbnail is switched to enlarged display (single display), as shown in FIG. 9.

FIG. 10 is a view for explaining an example wherein the recording contents of a memory card inserted into the card slot are displayed in the multi-frame mode, and an image selected from those displayed in the multi-frame mode is displayed in an enlarged scale. In this example, by vertically scrolling a cursor frame on thumbnails which are displayed in the multi-frame mode on the left side of the screen by operating the cursor key of the remote controller, an image corresponding to the thumbnail at the position of the cursor frame is displayed on the right display area in a single display mode.

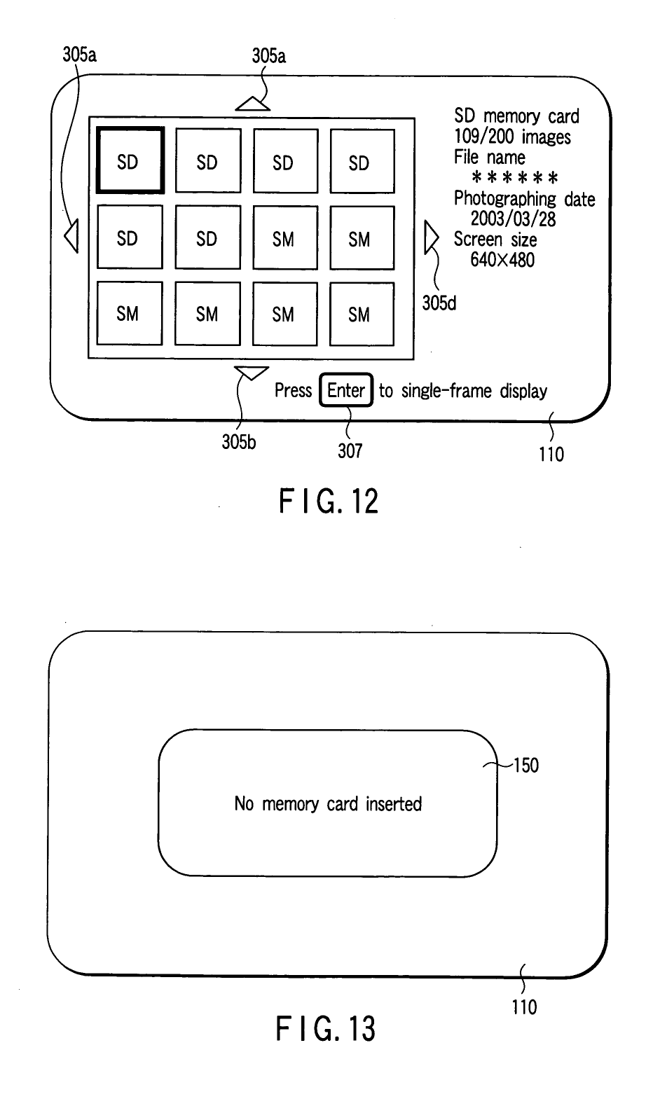

FIG. 11 is a view for explaining an example wherein the recording contents of two memory cards inserted into the card slots are simultaneously displayed in the multi-frame mode. FIG. 12 is a view for explaining another example wherein the recording contents of two memory cards inserted into the card slots are simultaneously displayed in the multi-frame mode. In the multi-frame display mode executed when a plurality of memory cards are inserted, a method of simultaneously display card contents while splitting the monitor display area in correspondence with cards without individually selecting the card may be used, as shown in FIG. 11. Alternatively, a method of simultaneously and seamlessly displaying image data (thumbnails) of all the memory cards may be used, as shown in FIG. 12.

FIG. 13 is a view for explaining a display message in “monitor display in a no-card state” in the process shown in FIG. 4. That is, when card detection circuit 14 detects that a memory card has been removed from a card slot, it is checked if a memory card remains inserted in another card slot, and if the memory card remains inserted, the display mode (step ST20) of that card is continued; otherwise, a normal received broadcast image is displayed on the monitor, or dialog box 150 indicating that no card is inserted is displayed on monitor screen 110, as shown in FIG. 13.

As described above, according to the embodiment of the present invention, when the user browses image data recorded on a memory card by a digital camera or the like, the recording contents (image data and their additional information as needed) can be automatically displayed or reproduced by only inserting the memory card into a card slot of the apparatus without any complicated operations.

According to the embodiment of the present invention, since insertion of one or a plurality of memory cards is detected, the mode for displaying digital image data starts instantaneously, and a plurality of thumbnails of image data stored in the memory card or cards are displayed, the user can easily browse digital image data without any complicated operations.

Note that the present invention is not limited to the aforementioned embodiments, and various modifications may be made without departing from the scope of the invention when it is practiced. That is, a memory card used in the embodiment of the present invention is not limited to a recording medium that stores only still pictures, and the present invention can be used to automatically display and/or automatically reproduce the recording contents of a memory card which records moving image data, audio data, text data, and the like together. Also, the respective embodiments may be combined as needed as long as possible, and combined effects can be obtained in such case.

Furthermore, the embodiments include inventions of various stages, and various inventions can be extracted by appropriately combining a plurality of required constituent elements disclosed in this application. For example, even when some required constituent elements are deleted from all the required constituent elements disclosed in the embodiments, an arrangement from which those required constituent elements are deleted can be extracted as an invention if the effect of the present invention is obtained.

As described in detail above, according to the present invention, a system which can automatically display and reproduce digital information recorded on a memory card by a simple operation can be provided.

What is claimed is:

1. A memory card automatic display method configured to be used with a system that comprises at least one card slot and an arrangement for reading recorded contents from a memory card inserted in the card slot, said method comprising:
a first step of detecting whether or not at least one memory card is inserted in the at least one card slot; and
a second step of, when the at least one memory card is inserted in the at least one card slot, entering into an image data display mode of automatically displaying one or more images indicating the recorded contents of the at least one inserted memory card, based on one or more manners in accordance with a number of inserted cards and/or a type of card.

2. A method according to claim 1, further comprising a third step of, when the at least one memory card is inserted in the at least one card slot and it is detected that a plurality of cards are inserted, selecting a prescribed one of the cards to be displayed.

3. A method according to claim 1, wherein the second step includes an ID read step of reading a card ID from the inserted card, and an information process step of outputting information associated with the recorded contents of the memory card specified by the read card ID, when the at least one memory card is inserted in the at least one card slot.

4. A memory card automatic display method configured to be used with an apparatus that comprises at least one card slot and an arrangement for reading recorded contents from a memory card inserted in the card slot, and has a function of power ON and power OFF, said method comprising:
a detection step of detecting whether or not at least one memory card is inserted in the at least one card slot; and
a display step of, when the at least one memory card is inserted in the at least one card slot upon the power ON, displaying a message indicating that the at least one memory card is inserted in the at least one card slot.

5. A method according to claim 4, wherein the display step includes a process step of, when the at least one memory card is inserted in at least one card slot and contents of the inserted memory card is to be browsed, displaying a message that prompts a user to re-insert that memory card or to make a card select operation.

6. A method according to claim 1, wherein the memory card has self identification information, and can have at least one of image information, audio information, and text information as the recorded contents.

7. A TV apparatus comprising:
a tuner configured to receive broadcasted information;
a display unit configured to display a moving picture corresponding to the broadcasted information received by said tuner;
at least one card slot with an arrangement configured to read recorded contents from a memory card inserted in the card slot;
a card detection unit configured to detect whether or not at least one memory card is inserted in the at least one card slot; and
an arrangement configured to, when the at least one memory card is inserted in the at least one card slot, automatically display one or more images using said display unit, said one or more images indicating the recorded contents of the at least one inserted memory card based on one or more manners in accordance with a number of inserted cards and/or a type of card.

8. An apparatus according to claim 7, wherein the at least one memory card has self identification information, and the identification information is configured to be used for identifying the memory card.

9. An apparatus according to claim 7, wherein the memory card can have at least one of image information, audio information, and text information as the recorded contents.

10. A method according to claim 4, wherein the memory card has self identification information, and can have at least one of image information, audio information, and text information as the recorded contents.

11. An apparatus configured to be used for automatically displaying said message as defined in claim 4.

12. The system as defined in claim 1 includes an AV apparatus in which a moving picture can be handled.

13. An apparatus for handling AV information including a moving picture, said apparatus comprising:
at least one card slot with an arrangement configured to read recorded contents from a memory card inserted in the card slot;
a first unit configured to detect whether or not at least one memory card is inserted in the at least one card slot; and
a second unit configure to, when the at least one memory card is inserted in the at least one card slot, enter into an image data display mode of automatically displaying one or more images indicating the recorded contents of the at least one inserted memory card based on one or more manners in accordance with a number of inserted cards and/or a type of card.
